(19) United States
(12) Patent Application Publication
(10) Pub. No.: US 2004/0054775 A1
(43) Pub. Date: Mar. 18, 2004

(54) Medical data collection and deliver system

(75) Inventors: Marius O. Poliac, St. Paul, MN (US); Charles F. Steaderman, Burnsville, MN (US); Michael J. Siers, Duluth, MN (US); Andrew P. Karels, Savage, MN (US); Victor F. Glava, Little Canada, MN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Poliac Research Corporation, Burnsville, MN

(21) Appl. No.: 10/606,611

(22) Filed: Jun. 26, 2003

Related U.S. Application Data
(60) Provisional application No. 60/391,899, filed on Jun. 26, 2002.

(51) Int. Cl. G06F 15/16

(52) U.S. Cl. 709/224; 709/206; 709/207

(57) ABSTRACT

A system that simplifies remotely accessing data retrieved from an apparatus. The system has an application development framework that allows an application developer to design specific applications using generic implementation information in the application development framework. The system may utilize a dedicated-function appliance separate from the apparatus or be embedded within the apparatus.

This application claims priority from U.S. Provisional Application No. 60/391,899 filed Jun. 26,2002 for MEDICAL DATA COLLECTION AND DELIVERY SYSTEM.

### BACKGROUND OF THE INVENTION

The present invention relates to a system for automated data collection and delivery. In particular, the present invention relates to a system that provides easy application development for data collection and delivery via electronic means including electronic mail.

While modems have greatly expanded the ability to monitor medical data remotely, the ongoing maintenance costs—dedicated phone lines, long-distance fees, dedicated computers, and program software—are significant. As a common device, the modem is also prone to theft.

Presently, home care facilities are limited in the methods by which they can remotely monitor patients. Each of these methods have significant disadvantages. The first method is to send a person out to the patient's home in order to extract the data from the medical device. The second method forces the patient to bring the device to the medical facility where the data can be easily downloaded. With the third method, the medical facility places a modem in the patient's home.

The first and second methods are neither efficient nor cost effective. Depending on how far the patient is from the medical facility, either method can be a significant burden on the person who is doing the traveling. With the third method, the medical facility has the burden of scheduling when to call out to the device or when the device should call into the medical facility. In addition, the medical facility must have enough phone lines to support, potentially, calls from a number of modems simultaneously. Moreover, the modems tend to disappear, because they are just standard off-the-shelf modems, which have other uses.

These issues are becoming more significant in that medical facilities are starting to consolidate. This means that each medical facility is actually managing patients in larger and larger geographical areas, so these medical devices are getting farther and farther away from the medical facility. Even if a modem is used, the costs still rise because of the incursion of long distance phone calls.

With the advent of the Internet and e-mail, a patient's distance from a medical facility becomes irrelevant as long as the patient's home can be connected to an Internet Service Provider using a local phone line connection. However, programming medical devices to relay their collected data requires extensive knowledge of computer programming. In addition, the patient must be knowledgeable in accessing the Internet and being able to deliver the data as an e-mail message to a healthcare provider. Many patients, especially elderly patients, are not comfortable doing this. Therefore, there is a need for a system that makes it easier, more efficient, and more cost effective to extract the data from medical devices and deliver that data to a healthcare provider.

### BRIEF SUMMARY OF THE INVENTION

The present invention is a system for remotely collecting data from an apparatus. The system has a microprocessing unit that provides interfaces to the apparatus and a communication link. The microprocessor has an application development framework that provides for easy application development.

The present invention may be within a dedicated-function appliance where the microprocessing unit is programmed to wake at scheduled times, collect data from a connected medical device, and send the data as electronic mail. A network server transmits the electronic mail to a location where it can be viewed.

### BRIEF DESCRIPTION OF THE DRAWINGS

FIG. 1 is a schematic diagram of one embodiment of a system using the remote data collector.

FIG. 2 is a schematic view of the remote data collector architecture.

FIG. 3 is a rear perspective view of the remote data collector.

FIG. 4 is a schematic diagram of a second embodiment of a system using the remote data collector.

FIG. 5 is a block diagram of the hardware architecture of the remote data collector.

### DETAILED DESCRIPTION

For illustration purposes, the present invention will be described in the context of remote collection of medical data from a patient. However, the present invention may be used, and is designed to be used, in any context where data must be collected from a remotely located apparatus.

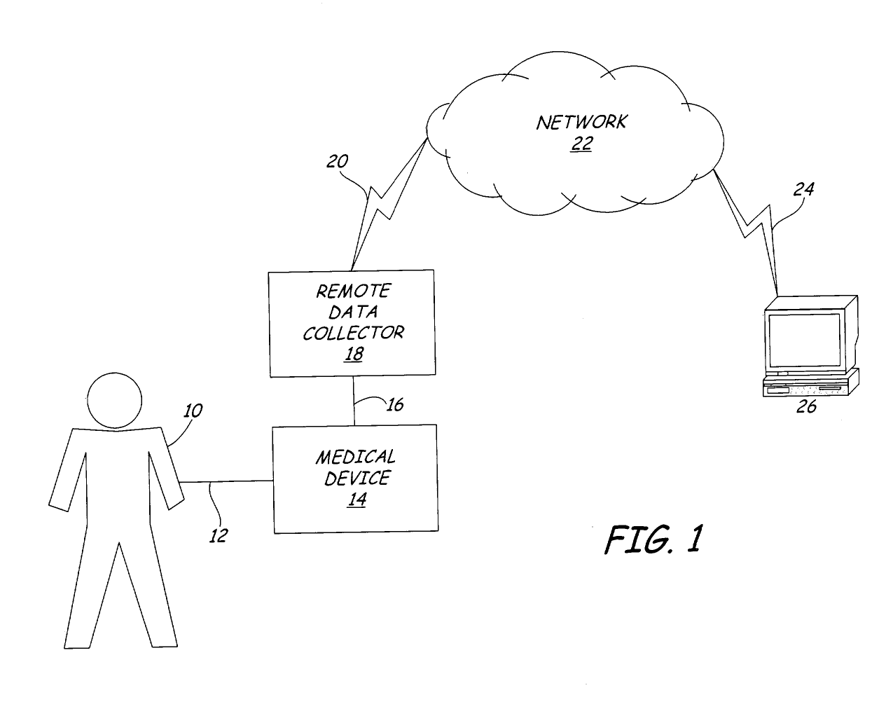

FIG. 1 illustrates a first embodiment of a system using the remote data collector. FIG. 1 includes patient 10, line 12, medical device 14, line 16, remote data collector 18, communication link 20, network server 22, communication link 24, and terminal 26. Medical device 14 monitors and collects data from patient 10 over line 12. Remote data collector 18 collects the data from medical device 14 via line 16 and transmits it through communication link 20, network server 22, and communication link 24 to terminal 18 as electronic mail (email). Line 16 preferably connects remote data collector 1 8 and medical device 14 by serial ports.

Remote data collector 18 can be simply programmed to wake at scheduled times, collect data from medical device 14, and send the retrieved data to a specific email address through an Internet Service Provider. Remote data collector 18 relieves many of the problems encountered with the current methods of retrieving remote data previously discussed.

Preferably, remote data collector 18 has a pass-through mode to allow remote configuration of medical device 14. In addition, remote data collector 18 can be programmed to make multiple attempts to send the data. If remote data collector 18 is unsuccessful in its attempts to send the data, it signals that it has data to send and patient 10 can manually push a send button, or the data will be sent with the next batch of data that is collected.

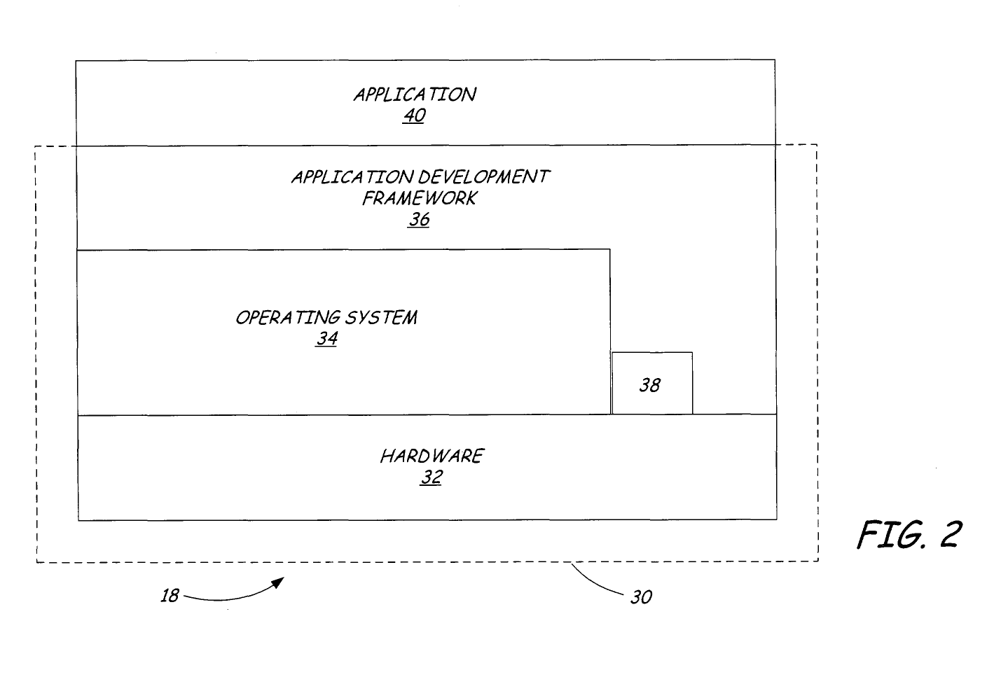

FIG. 2 provides additional detail of remote data collector 1 8 architecture. Remote data collector 18 includes microprocessing unit 30 with hardware 32, operating system 34, application development framework 36, and micromonitor 38; and application 40.

Microprocessing unit 30 is a generic and flexible platform for developing uses for remote data collector 18 in different environments and in conjunction with different devices. The architecture makes it easy to build on and add features or take features away if desired. It provides for a simple device from the standpoint of a user, but it performs very complex work.

To make remote data collector 18 simple and cost effective for an application developer, application development framework 36 and application 40 are abstracted from operating system 34. In operation then, application 40 is designed in a development environment, using application development framework 36, that is independent of the specific operating system 34 being utilized. Only a very small number of pieces within application development framework 36 need to change in order to support a different operating system 34.

There are significant benefits to using this type of architecture. First, different operating systems 34 have different costs associated with them. If the specific use of remote data collector 18 requires a lower cost, the cost can be lowered by installing an inexpensive operating system 34. Second, different operating systems 34 have different performance criteria associated with them. For example, some have more features than others or some are for larger programs. If application 40 has simple processing requirements, operating system 34 may use less resource memory and a smaller central processing unit. Third, it is simpler to develop application 40, because the application developer does not need to consider which operating system 34 will be used. The application developer does not need to know the details about operating system 34, because application development framework 26 hides the complexities of operating system 34 from application 40. Application development framework 36 provides a consistent way for the application developer to use the services available in operating system 34 independent of which operating system 34 is being used. Therefore, application developers will only have to learn application development framework 36 and not the different ways to communicate with different operating systems 34.

Application development framework 36 provides a standard i S mechanism for determining what a software element performs and how to interact with it by storing features and functions used by remote data collector 18. For example, remote data collector 18 possesses email capability. A new application developer does not need to determine how to send an email, how to talk from remote data collector 18 to network server 22, how to contact network server 22, what commands are required to send the data, how to structure an email message, etc. The developer does not need to reimplement these features for every new apparatus.

With typical programming, each component of software has its own set of commands that can be taken advantage of, and if a developer wants to take advantage of that piece of software, the developer must determine what commands to issue to that software for it to perform the function that it is designed to do. Therefore, the developer must learn all the different commands and available features and learn how to use them to have two software components talk to each other.

Remote data collector 18 circumvents this issue and makes application development more efficient through application development framework 36. Each object accessed by application development framework 36 implements one or more interfaces, and each interface contains a specific set of functions or commands. The sets of commands are compartmentalized based on the pattern, or interface, that defines them. Using this technique, applications 40 can be easily designed to run in completely different environments using the same sets of interfaces. An application developer does not have to create another object to implement each interface. One object can implement multiple interfaces.

Remote data collector 18 provides an easy means of implementing interaction between software components, because remote data collector 18 goes beyond mere basic documentation as to how the software behaves as is presently done. As described above, application development framework 36 has the functions grouped as patterns, or interfaces, and each interface is associated with an object. The documentation provided with remote data collector 18 first shows an application developer what interfaces are implemented by an object. If the developer needs more detail about the functions associated with the interfaces, the documentation will provide that detail. However, once the developer is familiar with the set of functions, or commands, that are associated with each interface, the developer will be able to implement that interface without having to go back to look at the set of associated functions. For example, if the developer wants to access a specific object and sees that it implements a stream interface, and the developer is familiar with application development framework 36, that is all the developer needs to know and simply asks for the stream interface. The developer does not need to know the specific object type, because the developer knows it behaves like a stream interface, which indicates what the software does.

Hardware 32 includes an interface between medical device 14 and microprocessing unit 30 and an interface between microprocessing unit 30 and communication link 20. Preferably, communication link 20 includes a modem that links to the Internet.

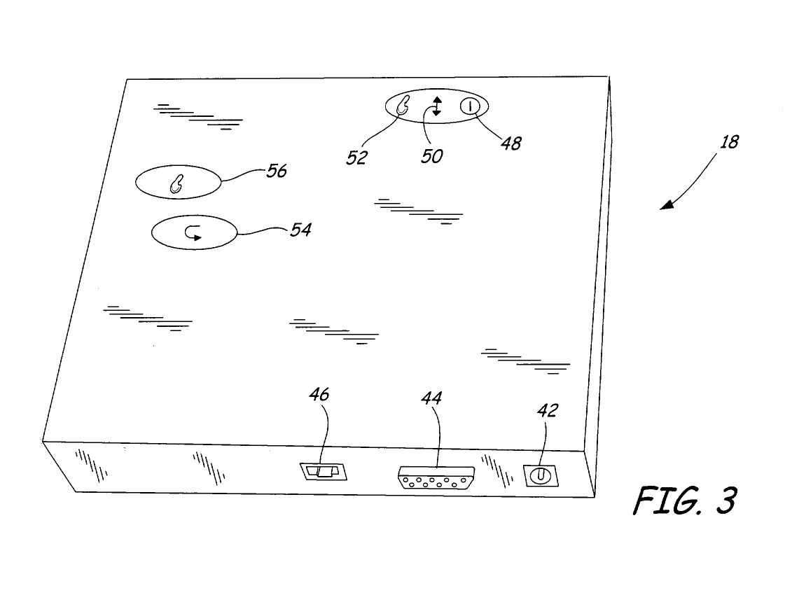

FIG. 3 is a perspective view of remote data collector 18 as a dedicated appliance. Remote data collector 18 includes external power supply input 42, external RS232 port 44, external Telco port 46, power indicator 48, data transfer indicator 50, auto answer indicator 52, send button 54, and auto answer button 56.

Power is supplied to remote data collector 18 via external power supply input 42, connection between the medical device and remote data collector 18 is provided through external RS232 port 44, and connection between remote data collector 18 and a phone line is through external Telco port 46. Power indicator 48 signals that remote data collector 18 is turned on, data transfer indicator 50 signals that data is being transferred from remote data collector 18 to a remote location, and auto answer indicator 52 signals that remote data collector 18 is in auto answer mode.

Send button 54 allows the user to manually send data stored in remote data collector 18 rather than having remote data collector 18 do it automatically. Auto answer button 56 activates the auto answer mode so that remote data collector 18 will answer an incoming call over the phone line.

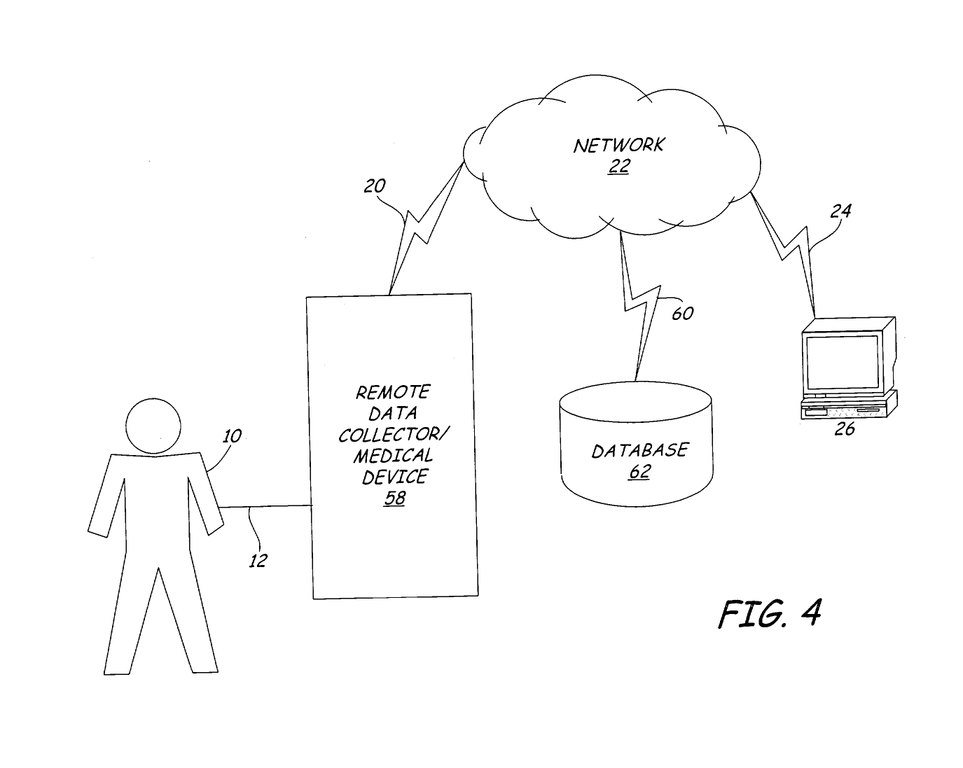

FIG. 4 is a schematic view of an alternative embodiment of a system using remote data collector 18. FIG. 4 includes patient 10, line 12, embedded medical device 58, communication link 20, network server 22, communication link 24, terminal 26, communication link 60, and database 62.

In operation, remote data collector 1 8 is embedded into embedded medical device 58 instead of being a separate appliance. Overall, remote data collector 18 functions identically as that described above.

FIG. 4 further shows that the data collected from embedded medical device 58, or medical device 14 if using the embodiment of FIG. 1, can be transmitted to and stored in central database 62. A healthcare provider can access the data from database 62 using terminal 26 via communication links 24 and 60 and network server 22.

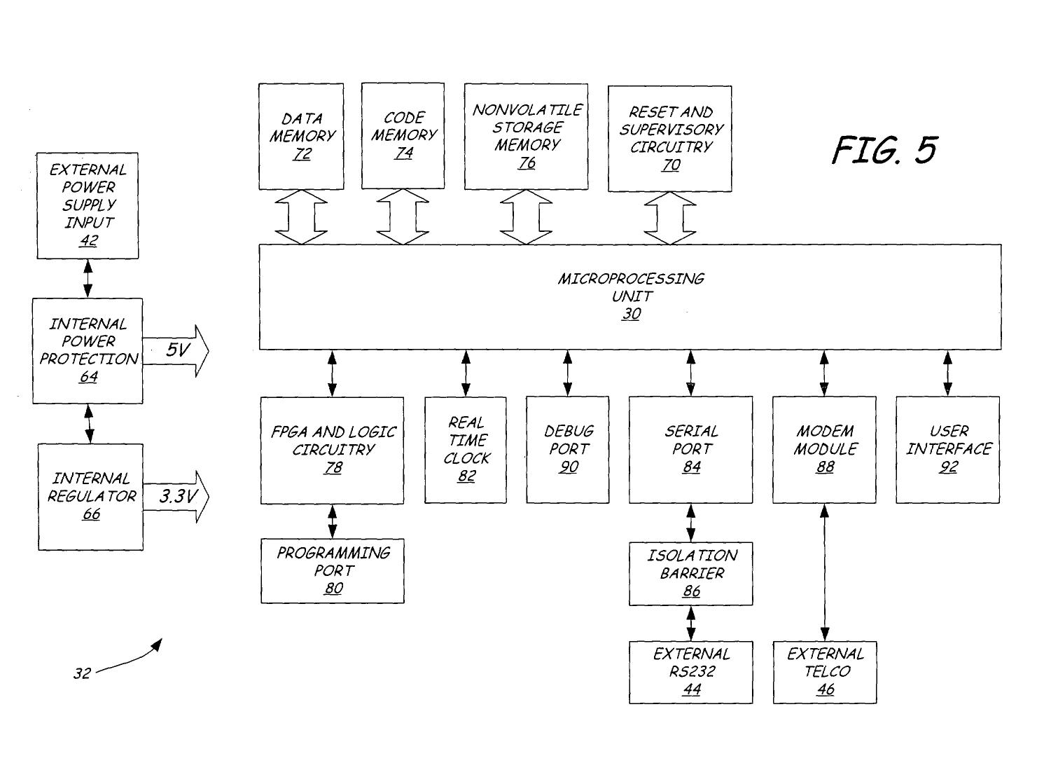

FIG. 5 details one embodiment of the architecture of hardware 32 used by remote data collector 18. Hardware 32 includes external power supply input 42, internal power protection 64, internal regulator 66, microprocessing unit 30, reset and supervisory circuitry 70, data memory 72, code memory 74, nonvolatile memory 76, fpga and logic circuitry 78, programming port 80, real time clock 82, serial port 84, isolation barrier 86, external RS232 port 44, modem module 88, external Telco 46, debug port 90, and user interface 92.

In operation, remote data collector 18 is powered from a regulated +5V DC switching or linear external wall mount or tabletop source supplying at least 500 mA through external power supply input 42. For medical applications, the power supply must comply with dielectric withstand voltage and leakage current requirements. Preferably, a power supply jack will permit connection to an external power supply with a female barrel type connector (5.5×2.1×11 mm) with positive at central pin and negative at outside.

Internally, remote data collector 18 is protected from over voltage and over current with internal power protection 64 supplied at external power supply input 42. Internal power protection 64 will limit the incoming voltage at +6V DC by generating a shunt current that trips the over current protection. Internal power protection 64 will also limit total current at less than 1,500 mA in seconds. The amount of time to trip internal power protection 64, which is resettable, depends on temperature, current magnitude, and rate of current increase. Reverse polarity protection for the external power supply is also provided by means of a switching high current, ultra fast rectifier.

The external regulated +5 VDC is converted and regulated to 3.3V by internal regulator 66, which is a low dropout fixed output regulator providing a range of output of 3.235 to 3.365 V DC over the full operating temperature. The maximum 500 mA output current needed by the board circuitry and the power dissipation of 0.975 w (at the highest input value of 5.25 V) are well within the specification of internal regulator 66.

Power to almost all internal circuitry is supplied after conversion and regulation to 3.3 V by internal regulator 54. Electrical isolation circuitry and external signaling LEDs (discussed below) are the only components using externally supplied +5 V DC.

Remote data collector 18 is controlled by microprocessing unit 30, which may be a Motorola MCF5206e integrated 32 bit microcontroller. Microprocessing( unit 30 combines a ColdFire core with several peripherals functions such as a DRAM controller, timers, general-purpose I/O and serial interfaces, debug module, and system integration. With a clock speed of 40 MHz, microprocessing unit 30 provides reliable, high speed signal processing.

Microprocessing unit 30 uses reset and supervisory circuitry 70, which is a dedicated chip, for supply voltage monitoring as well as power-on reset generation. Some logic is applied to the generated signal that is also used to ensure proper reset to on-board components and peripherals.

Data memory 72 is provided on-board. Data memory 72 may be two 1 M×16 bit CMOS, low power, high speed, dynamic RAM chips giving a 4 Mbyte data memory space. Data memory 72 is accessed in a glueless interface by the DRAM controller of microprocessing unit 30 in 32 bit dataport size and 512 byte page size mode. Data memory 72 is located in bank 0 of 16 Mbyte address space, starting at address 0×04000000.

Code memory 74 is also provided on-board and may be one 1 M×16 bit CMOS, low power, high speed, fast program and erase times flash memory chip. Code memory 74 is interfaced with direct bus access by microprocessing unit 30 in the upper 16 bit portion of the 32 bit data port size and is located at address space 0×00000000. Code memory 74 can be programmed and erased in-system with a single 3.3 V DC supply allowing for easy code updates. Code memory 74 can also be programmed in standard eprom programmers for production code pre-loading.

Nonvolatile storage memory 76 is provided on-board for data retention. Nonvolatile storage memory 76 is comprised of a two wire serial EEPROM chip memory of 32 kbyte nonvolatile memory. A simple two wire serial interface is configured using data masking and decoding with programmed logic in the onboard fpga (discussed below) and a minimum of external components. The chip endurance of nonvolatile storage memory 76 is 100,000 write cycles and can be increased using a smaller size memory chip installed on the same component footprint. To reduce writing time that can be as long as 10 mS per write cycle, up to 64 bytes can be sent with automatic address increment and a single internal write cycle.

Most of the glue logic and interface circuitry is implemented in fpga and logic circuitry 78, which is a fpga (field programmable gate array) chip with 4 logic array blocks, 64 macrocells, and 66 I/O pins. Fpga and logic circuitry 78 can be programmed in-system, using the 3.3 V DC supply, a parallel port download cable, and software utility for easy code updates. Fpga and logic circuitry 78 can also be programmed with a variety of available external programmers for production code pre-loading. In the present embodiment, 87% of total I/O pins are used, and 50% of total logic cells are used. Fpga and logic circuitry 78 uses a four pin interface, shown as programming port 80, to connect to the PC parallel port through a download cable to configure and update fpga and logic circuitry 78.

Real time clock 82 may be a two wire serial interface chip. The serial interface is configured using data masking and decoding with programmed logic in fpga and logic circuitry 78 and a minimum of external components. An internal oscillator circuitry is designed to work with an external 32.768 kHz oscillator for accurate time generation. An internal power sense circuit will detect power failures and automatically switch to a battery supply. Real time clock 82 is low power—it consumes less than 500 nA in battery backup mode allowing the battery to last for years before requiring replacement.

To ensure compliance with the strict patient safety standards that apply to the electronic equipment and circuitry in a medical application, remote data collector 18 provides isolation barrier 86 on external RS232 port 44. External RS232 port 44 is a nine pin DB9 male connector in data circuit-terminating equipment (DCE) configuration and isolated ground. Power as well as four digital signals ( transmit data-TXD, receive data-RXD, clear to send-CTS, request to send-RTS) are conveyed across isolation barrier 86. The elements of isolation barrier 86 include digital optocouplers, a pulse transformer, and an 8 mm circuitry gap. These elements are certified to withstand a 4,000 V test along with other requirements for compliance with medical safety standards. Specialized drivers/receivers chipset allow the complete circuitry to work from a single +5 V DC supply at the required 60 kHz data transfer speed.

Modem module 88 is preferably a simple, space efficient embedded modem that provides 33.6k (enhanced V.34) data communication. Modem module 88 preferably complies with telecom requirements globally and can be shipped worldwide. It uses the 3.3 V DC on-board supply and accepts standard AT commands for configuration and control. It interfaces with microprocessing unit 30 through a serial channel, and buffering is performed in fpga and logic circuitry 78. Modem module 88 complies with the limits for a class B digital device, pursuant to Part 15 of the FCC rules.

External Telco port 46, which may be a double RJ-11 jack, supplies connection between modem module 88 and a public switched telephone line and an additional phone line.

Communication with a system debugger is handled via debug port 90, which is a dedicated, high-speed serial command interface. The ColdFire family supports a modified version of the Background Debug Mode that implements a low-level system debugger in microprocessing unit 30 hardware. Debug port 90 is used during system development and remains available on-board for further use.

User interface 92 preferably consists of two LED's and two push-buttons that are controlled using input and output lines along with data masking and decoding with programmed logic in fpga and logic circuitry 78 and a minimum of external components. Power indicator 48 is hardwired to the +5 V power supply.

The following microprocessing unit 30 peripherals are interfaced with programmed logic in fpga and logic circuitry 78: Reset and supervisory circuitry 70, Nonvolatile storage memory 76, Real time clock 82, Modem module 88, and User interface 92.

Two on-board connectors used during development and programming remain available for future use or configurations and updates.

When remote data collector 18 is in use, at a specified time or in response to manual activation, application 40 issues a Download request to the interface between medical device 14 and microprocessing unit 30 and specifies a memory stream into which its data should be placed. The memory stream is preferably a Data Processor Factory, which is responsible for compressing the data and encoding it appropriately to be sent as an email attachment. The interface in turn issues a Connect request to the dispatcher for external RS232 port 44. Upon receipt of the Connected response from the dispatcher, the interface begins downloading data from medical device 14, placing it into the memory stream provided by application 40. After the data is downloaded, the interface signals to application 40 that the download is complete.

Application 40 then sets the collected data stream into the email component along with the recipient's email address and issues a Send command. The email component issues a Connect message to the dispatcher for modern module 88. When the email transmission is complete, the email component notifies application 40 that the email transmission is complete.

If a new external device needs to be interfaced for a different application, an interface specific for the new external device is the only component which needs to be changed. The programmer simply needs to implement the same function interfaces that the previous interface implemented and execute the appropriate commands to communicate with the new device. All other aspects of the system remain the same.

Remote data collector 18 provides a means for easy collection of data from a remote location. Application development framework 36 allows easy programming of remote data collector 18, which is independent of the type of operating system used in the appliance from which data is being collected. Thus, the present invention provides an easy, efficient, and cost effective way of extracting and delivering data from remote locations.

Although the present invention has been described with reference to preferred embodiments, workers skilled in the art will recognize that changes may be made in form and detail without departing from the spirit and scope of the invention.

1. A system for automated remote data collection using data retrieved from an apparatus, the system comprising:
a microprocessing unit;
a first interface between the apparatus and the microprocessing unit;
a communication link; and
a second interface between the microprocessing unit and the communication link;
wherein the microprocessing unit contains an application development framework for developing applications that utilize generic implementation information provided by the application development framework.

2. The system of claim 1 and further comprising:
an application created by the application development framework; and
an operating system that administers the application through the application development framework.

3. The system of claim 1 wherein the communication link is an Internet link.

4. The system of claim 3 wherein a user manually indicates to send retrieved data as electronic mail.

5. The system of claim 3 wherein retrieved data is transmitted as electronic mail.

6. The system of claim 3 wherein retrieved data is transmitted as electronic mail to a central database.

7. The system of claim 6 wherein the retrieved data is accessed with a computer having a web browser.

8. The system of claim 1 wherein the microprocessing unit, the first interface, the communication link, and the second interface are embedded in a dedicated-function appliance.

9. The system of claim 1 wherein the microprocessing unit, the first interface, the communication link, and the second interface are embedded within the apparatus.

10. The system of claim 1 wherein the application development framework implements interaction across the first interface and the second interface.

11. The system of claim 2 wherein the application provides information regarding the apparatus type, data collection, and data delivery that is specific to a user.

12. The system of claim 1 wherein the system supports a plurality of apparatuses.

13. The system of claim 2 wherein the application development framework allows the application to be created and administered regardless of the operating system that is used.

14. The system of claim 1 wherein the application development framework allows the application to be created and administered regardless of the communication link that is used.

15. The system of claim 1 wherein the apparatus is configured remotely.

16. A system for automated collection and delivery of patient data, the system comprising:
a medical device; and
an appliance having a microprocessing unit that wakes at scheduled times, collects data from the medical device, and sends the data as electronic mail.

17. The system of claim 16 and further comprising:
a network server to transmit the electronic mail to a location where the data contained in the electronic mail can be viewed.

18. The system of claim 16 and further comprising:
a database to store the data transmitted by a network server; and
a computer with a web browser to access the data.

19. The system of claim 16 and further comprising:
a computer in communication with a network server to receive the electronic mail.

20. The system of claim 16 wherein the microprocessing unit further comprises:
an operating system;
an Internet link;
an application development framework to design applications specific to the medical device and a patient; and
an application designed with the application development framework.

20. The system of claim 16 wherein the medical device is configured remotely through a modem.
